(19) United States
(12) Patent Application Publication
(10) Pub. No.: US 2009/0048735 A1
(43) Pub. Date: Feb. 19, 2009

(54) METHOD AND DEVICE FOR CONTROLLING TURNING ANGLE OF A MOTOR VEHICLE REAR WHEEL

(75) Inventor: Stephane Guegan, Versailles (FR)

Correspondence Address: OBLON, SPIVAK, MCCLELLAND MAIER & NEUSTADT, P.C., 1940 DUKE STREET, ALEXANDRIA, VA, 22314, US

(73) Assignee: RENAULT S.A.S., BOULOGNE-BILLANCOURT (FR)

(21) Appl. No.: 12/097,272

(22) PCT Filed: Oct. 16, 2006
(86) PCT No.: PCT/FR06/51035

§ 371 Date: Jun. 13, 2008

(30) Foreign Application Priority Data
Dec. 23, 2005 (FR) 0513228

(51) Int. Cl. B62D 6/00

(52) U.S. Cl. 701/42; 701/41

(57) ABSTRACT

A device including a mechanism that executes a control law and a mechanism responsive to a rear wheel turning angle instruction derived from the control law for making the angle dependent on the instruction. Further, a mechanism monitors signals representing input variables of the control law, designed to indicate an error in the current value of one of the variables and in replacing the current value with a previous certain value of the variable. In a case of a persistent error, the control law is replaced by a mode involving secure computing of the rear wheel turning angle.

The present invention relates to a method for controlling the steering angle of the steered rear wheels of a motor vehicle comprising a front axle of steered front wheels, the steering angle of which is set by a steering wheel and a rear axle of steered rear wheels, whereby said rear wheel steering angle is taken from a control law that is a function of input variables comprising at least the angle of rotation of the steering wheel and the speed of the vehicle. The present invention also relates to a device for implementing this method. The present invention also relates to a motor vehicle equipped with such a device.

A method and device such as these are known from French patent application No. 2 864 001 filed on Dec. 18, 2003 by the Applicant Company. These provide control of the steering angle of the rear wheels of a motor vehicle of the type said to have “four-wheel steering” comprising a chassis supported by an axle comprising two front wheels, the steering angle of which is set by a steering wheel turned by the driver of the vehicle, and by an axle comprising two rear wheels, the steering angle of which is set by an actuator, such as an electric motor for example, controlled by a computer duly programmed to execute a control law to control this angle as a function at least of the steering angle of the front wheels and of the speed of the vehicle.

If it happens that these input variables for the control law adopt erroneous values, then the value of the rear steering angle instruction determined using the control law will then also be in error. In the worst case scenario, this could conceivably result in a loss of control of the vehicle by the driver and therefore represent a situation dangerous to the driver and any passengers he may be carrying. It is therefore appropriate to set in place means that will allow this risk to be eliminated.

It is precisely the object of the present invention to provide means of improving the safety of the control method mentioned hereinabove.

It is another object of the present invention to provide such a safer method of control suited to a motor vehicle equipped with a local communications network comprising a signal distribution bus, particularly distributing signals representative of the input variables of the control law used by this method.

These objects of the invention, together with others which will become apparent from reading the description which will follow, are achieved with a method for controlling the steering angle of the rear wheels of a motor vehicle comprising a front axle of steered front wheels, the steering angle of which is set by a steering wheel and a rear axle of steered rear wheels, whereby the rear wheel steering angle is taken from a control law that is a function of input variables comprising at least the angle of rotation of said steering wheel and the speed of said vehicle, this method being notable in that the appearance of an erroneous value of at least one of the input variables is detected and in that this value is then replaced with a reliable earlier value of the variable.

By thus replacing the erroneous current value with a valid and recent earlier value capable of being truly representative of the actual current value of the variable in question, the control law is allowed to produce a correct value of the rear steering angle that is unaffected by the detected error.

According to other features of the present invention:
if the production of the erroneous value persists for a length of time longer than a predetermined duration, then a safer method of calculating the rear steering angle is substituted for the method of calculating this angle defined by the control law;
the safer method of calculation progressively returns the rear steering angle to zero;
the method is employed in a vehicle equipped with a local communications network comprising a bus for distributing at least said input variables in the form of sampled digital data. Upon detection of an erroneous value in a current sample of one of the digital data, this sample is replaced by a reliable earlier sample of the data, for calculating the rear steering angle using the control law;
the value of the current sample of the data available on said bus is compared against values indicating its invalidity or its absence on the bus, and the value of a flag indicating either one of said invalidity or said absence is set accordingly;
over a sampling period, the vehicle speed gradient is measured, this gradient is compared against a predetermined limit value of this gradient and the value of a flag indicating any exceeding of this limit value is set accordingly;
the steering wheel angle of rotation gradient is measured, this gradient is compared against a predetermined limit value of this gradient and the value of a flag indicating any exceeding of this limit value is set accordingly;
the measurement of the gradient is timed;
with one of the input variables consisting of the direction of travel of the vehicle, consistency of this variable as read off said bus with the state of the vehicle, in forward gear or reverse or alternatively stationary, is checked and the value of a flag indicating any error in the current sample of this variable is set accordingly;
while any one of the aforementioned flags remains in the state indicating an error with the associated input variable for a length of time that exceeds a predetermined duration, the rear steering angle is calculated using the safer method of calculation.

In order to implement the method according to the invention, this invention provides a device comprising means capable of executing the control law and means sensitive to a rear steering angle instruction taken from this law in order to force this angle to adopt this instructed value, this device being notable in that it comprises means of monitoring signals representative of the input variables of the control law which are capable of indicating an error in the current value of any one of these variables and of replacing this current value with a reliable earlier value of the variable.

According to other features of this device:
the means of executing the control law comprise means of executing a safer method of calculating the rear steering angle;
the device also comprises state management means sensitive to detection of an error by the means of monitoring the signals and to safer signals delivered by these monitoring means with regard to the speed and direction of travel of the vehicle, so as to deliver reliable information regarding the state of the vehicle, whether stationary, in a forward or reverse gear, to the means of executing the control law so that the means of executing this control law can select this law appropriately;
this information is also delivered to the monitoring means, these comprising means of checking the consistency of the variable relating to the direction of travel of the vehicle with said information.

Further features and advantages of the present invention will become apparent from reading the description which will follow and from studying the attached drawings, in which:

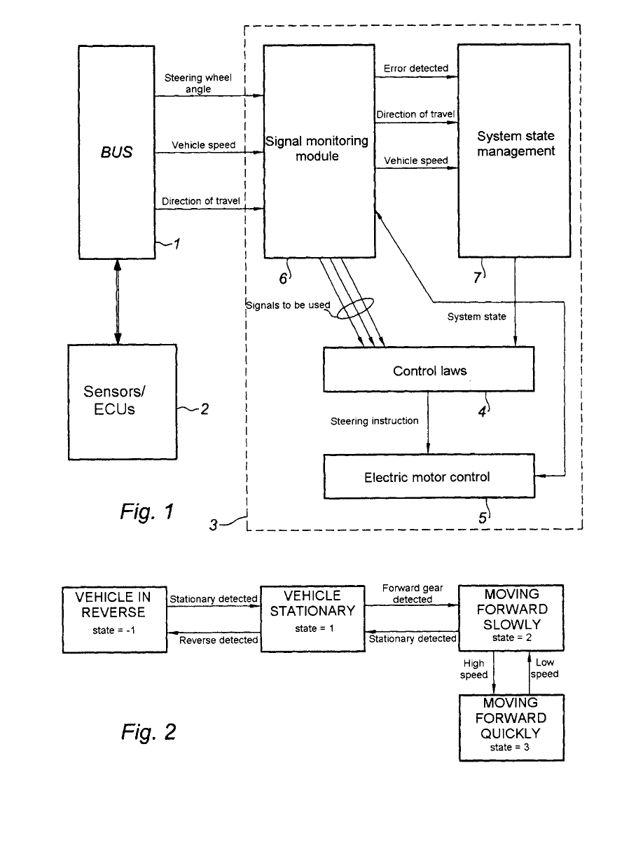

FIG. 1 is a block diagram of the device for controlling the steering angle of a rear wheel according to the present invention,

FIG. 2 is a functional diagram of a module known as a “state management module” from the block diagram of FIG. 1, and

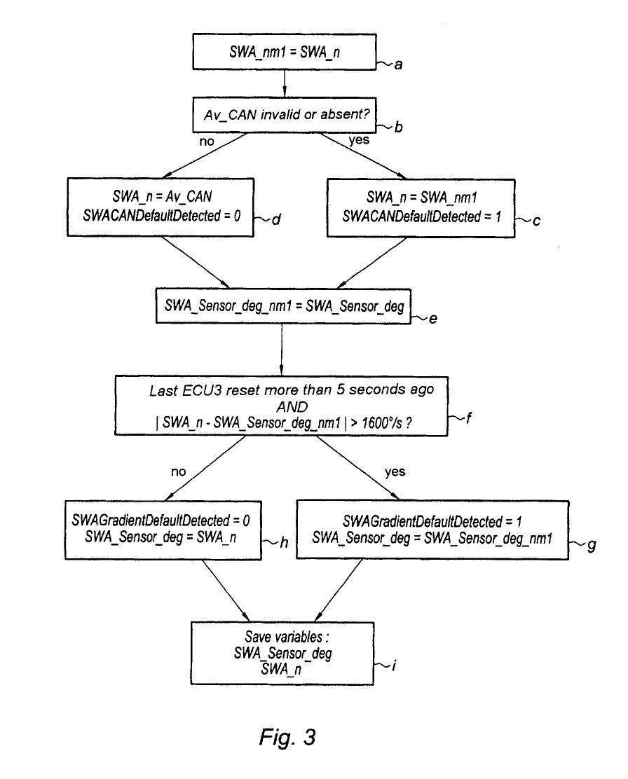

FIGS. 3, 4 and 5 are flow diagrams for programs for detecting and correcting errors in the current values of the angle of rotation of the steering wheel, of the speed of the vehicle and of the direction of travel of the vehicle, respectively, illustrating the method of the invention.

Reference is made to FIG. 1 of the attached drawing where it can be seen that, according to a preferred embodiment of the present invention, this invention is incorporated into a motor vehicle equipped with a local data communications network such as the CAN network commonly incorporated into recent designs of motor vehicles. A network such as this notably comprises a bus 1 interconnecting various sensors and computers grouped together under the reference 2. As is well known, the sensors supply the computers (also known as electronic control units ECU) with sampled digital signals representative of variables involved in the management, by these computers, of the functional assemblies of the vehicle such as the power plant, the suspension or the antilock braking system of the vehicle for example.

The device according to the invention is incorporated into this system in the form of a digital computer 3, which may be dedicated or shared with other assemblies of the vehicle. This computer is duly programmed to execute one or more control laws 4 for controlling the rear steering angle. In this connection, reference may be made to the aforementioned French patent application No. 2 864 001 to gain an understanding of the features of a control law that can be used in the present invention. Of course, this reference is given merely by way of illustrative and nonlimiting example.

A steering instruction is taken from the control law and delivered to control means 5 for controlling an actuator (not depicted) capable mechanically of setting the steering angle of the rear wheels of the vehicle to the value of the instructed angle. As seen above, an actuator such as this may consist of an electric motor controlled in terms of position and/or in terms of power.

The computer 3 is connected to the bus 1 in order to pick off the bus signals representative of sampled current digital values of the input variables of the control law 4. As seen above, these variables comprise at least the angle of rotation of the steering wheel and the vehicle speed. These variables are input to the bus by measurement or calculation means well known in the art. In the present invention, these variables advantageously also comprise the direction of travel of the vehicle. This variable adopts three distinct values according to whether the vehicle is in a forward or reverse gear or alternatively stationary. This information allows control laws to be activated that are parametrized differently according to whether the vehicle is running in forward gear or in reverse or even, as will be seen later on, according to whether it is moving forward at a low speed or at a high speed.

According to one feature of the present invention, the signals available on the bus 1 and representative of the steering wheel angle, of the speed of the vehicle and of the direction of travel of the vehicle, respectively, are first of all processed in a signal monitoring module 6 before being handed over to the means 4 of executing the control laws for controlling the rear steering angle. The processing operations applied to these signals will be detailed later on in conjunction with FIGS. 3 to 5.

FIG. 1 also shows that the signal processing module 6 delivers, to a module 7 known as a “state management module” of the system consisting of a vehicle equipped with the device according to the present invention, information relating to the direction of travel and to the speed of the vehicle and also indicates to it any error detected in the signals processed in this module. The block diagram of FIG. 2 details the functionalities of the module 7. The module 7 identifies the current operating state of the vehicle, which may be reverse gear (state=−1), stationary (state=1), forward gear at low speed (state=2) or at high speed (state=3). Using the signals supplied it detects transitions between these various states, which transitions are represented in FIG. 2 by arrows identifying the transitions detected: Stationary_detected, Forward gear_detected, Reverse gear_detected, High speed, Low speed.

The module 7 delivers this state information to the means 4 of executing the control laws 4, to the means 5 of controlling the electric motor, and to the signal monitoring module 6. This state information allows the means 4 to select the control law suited to the state detected. Thus, the strategy for controlling the rear steering angle may be different between forward gear and reverse gear, and even between moving forward slowly and moving forward quickly. As will be seen later, if a persistent error is detected in at least one of these input variables of the applicable control law then a “degraded”, but safer, method of calculating the rear steering angle is selected by the execution means 4.

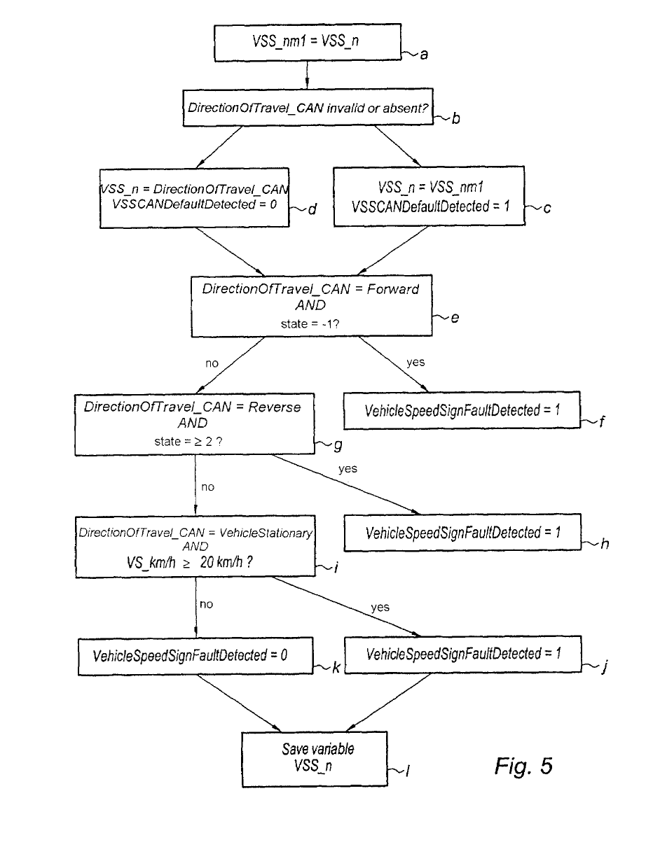

As will be seen in detail in conjunction with FIG. 5, the state information delivered by the module 7 is also exploited by the signal monitoring module 6 to check the consistency of changes in the signal relating to the direction of travel of the vehicle as delivered by the bus 1. This check makes this information more reliable by detecting an error therein, this error being detected if its change is inconsistent with the state of the system.

Reference is now made to the flow diagram of FIG. 3 in order to detail the steps in the strategy applied by the signal processing module to detect the appearance of any error in the current sample of the value of the steering wheel angle read on the bus 1, and for therefore correcting or compensating for this error.

When each current sample SWA_n of the variable Av_CAN relating to the steering wheel angle appears on the bus 1 of the CAN network (step a), the module 6 compares this sample against values that indicate the absence or invalidity of the information available on the bus relating to this variable (step b). If the result of this test is positive then a “flag”, SWACANDefault_Detected is set to 1 and the current sample SWA_n is replaced with the immediately previous sample of rank (n−1), namely SWA_nm1 (step c). If not, the sample SWA_n is validated as being representative of the steering wheel angle Av_CAN as read on the bus and the aforementioned flag is set, or confirmed, at 0 (step d).

The value, in degrees, of the steering wheel angle, as detected by the steering wheel angle sensor and that is to be used by the other blocks of the computer 3 is termed SWA_sensor_deg. In step e, this value is equated with that of the previous sample of rank nml of this value.

It will be appreciated that this use of the immediately previous sample is perfectly legitimate under normal vehicle running conditions because the steering wheel angle is then changing slowly over the period of the sampling frequency of the signal delivered by the steering wheel angle sensor, this period commonly being of the order of 10 ms.

Incidentally, it has been possible to establish experimentally that the steering wheel angle cannot vary at a rate in excess of 1600°/s. Any overstepping of this value therefore means that there is an error in the measuring of this angle. In step f, this validity condition is tested by comparing the absolute value of the gradient or rate of change of steering wheel angle between the sampling instants nml and n, against a limit value considered to be a maximum. With the sampling period of 10 ms given hereinabove, this limit value is then 16°, namely 1600°/s. The measuring of the gradient is timed, every 5 s for example from the last zeroing (resetting) of the computer 3 so as to avoid detecting gradients in excess of this limit value during phases in which the computer is warming up and initializing, during which phases jumps in values may occur as a result of this computer changing state, these being liable to give rise to false detections of errors.

If this limit value is exceeded, then a flag SWAGradientDefaultDetected is set to 1 and the previous sample of rank nml of the steering wheel angle SWA_Sensor_deg is used in the next blocks (step g). If not, this flag remains at 0 and the current sample SWA_n available on the bus is used in the forthcoming calculations (step h). In step i, the value of SWA_Sensor_deg is saved and used thereafter by the execution means 4 that execute the control law, together with the value SWA_n.

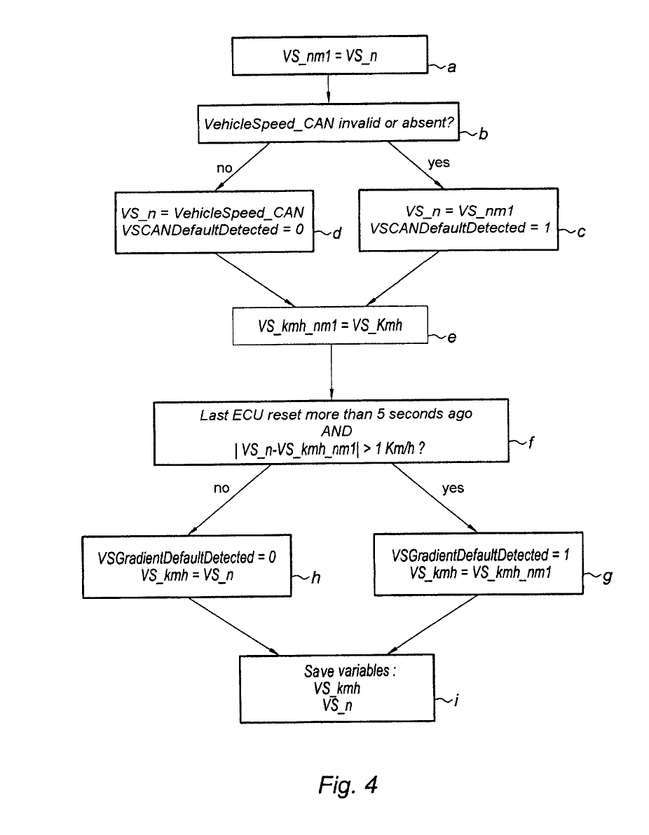

Reference is now made to the flow diagram of FIG. 4 in order to detail the steps in the process of detecting any error in the measurement of the vehicle speed, and for correcting or compensating for this error. Incidentally, this process is very similar to the one described hereinabove in conjunction with FIG. 3 regarding the steering wheel angle.

When each sample VS_n of the current value VehicleSpeed_CAN of the vehicle speed appears on the bus 1 of the CAN network (step a), the module 6 compares this sample against values indicative of the absence or invalidity of this sample (step b). If the result of this test is positive, then a “flag” VSCANDefault_Detected is set to 1 and the current sample VS_n is replaced with the immediately previous sample VS_nml (step c). If not, the sample VS_n is validated as being representative of the vehicle speed VehicleSpeed_CAN such as read on the bus and the aforementioned flag is set, or confirmed, at 0 (step d).

The value, in kmh of the speed of the vehicle as detected by a sensor suited to this measurement and to be used by the other blocks of the computer 3 is termed VS_kmh. In step e, this value is equated with that of the previous sample of rank nm1 of this value.

This substitution is legitimized by an observation similar to the one mentioned hereinabove with regard to the steering wheel angle, as the vehicle speed normally varies very little during the sampling period, here set at 20 ms.

Incidentally, it has been possible experimentally to establish that the vehicle speed cannot vary by more than 1 kmh during the 20 ms. Any overstepping of this value therefore means that there is an error in the detection of this speed. In step f, this validity condition is tested by comparing this limit value against the absolute value of the gradient or rate of variation of speed between the sampling instants nm1 and n. The measuring of the gradient is timed, every 5 s for example, from the last zeroing (resetting) of the computer 3.

If this limit value is exceeded, then a flag VSGradientDefaultDetected is set to 1 and the previous sample of rank nm1 of the speed VS_kmh_nml is used in the other blocks of the computer (step g). If not, this flag remains at 0 and the current sample VS_n available on the bus is used in the forthcoming calculations (step h). In step i, the value of VS_kmh, subsequently used by the execution means 4 that execute the control law, is saved, together with VS_n.

Reference is now made to the flow diagram of FIG. 5 to describe the process of detecting an error and of correcting the information available on the bus 1 and relating to the direction of travel of the vehicle.

It will be appreciated that it is essential to have reliable information on this aspect. This is because the rear steering angle control strategies differ greatly according to whether the vehicle is moving forward or in reverse. If the “direction of travel” information suddenly, and erroneously, switches from a value corresponding to the forward gear to a value corresponding to the reverse gear, when the vehicle speed is non-zero, then the rear steering angle instruction will also jump sharply from the current value to an appreciably different value because of the fact that two different control laws will have been called up in turn for calculating these values. The ensuing jump in rear steering angle is liable to place the driver of the vehicle in a tricky situation.

To prevent this risk, according to the present invention, the state management module 7 of the system delivers information relating to the state of this system to the signal monitoring module 6 to allow the latter to ensure consistency between the value of the “direction of travel” information and the changes in state of the signal as determined by the module 6.

On the state diagram depicted in FIG. 2, it can in fact be seen that, in order to switch from a mode of operation in a forward gear, moving forward slowly or quickly, to a mode of operation in reverse gear, the system has a necessity to pass via the “vehicle stationary” state. The “direction of travel” information received by the module 6 has to remain consistent with the state of the system, as established by the module 7, as do changes therein.

The flow diagram of FIG. 5 explains the process of verifying this consistency.

First of all, just as was the case with the steering wheel angle and the vehicle speed, if the direction of travel information VSS_n read on the bus is absent or has adopted the value that represents the fact that it is invalid, then a VSSCANDefaultDetected flag is set to 1. If not, it is set to zero (see steps a to d). Depending on the situation, the sample VSS_nm1 or VSS_n is adopted as the DirectionOfTravel_CAN information used subsequently as being representative of the direction of travel of the vehicle as can be read on the bus.

The consistency or possible inconsistency between the information relating to the state as delivered by the module 7 and that supplied by the DirectionOfTravel_CAN information delivered by the bus is then examined in the three possible states of the vehicle (forward gear, reverse gear, vehicle stationary).

Thus, step e looks for the emergence of a situation in which the DirectionOfTravel_CAN information indicates forward gear whereas the system, as seen by the state management module 7, is in state −1 relating to reverse gear. Upon detection of such a situation, a VehicleSpeedSignFaultDetected flag is set to 1 (step f). In the absence of such a situation this flag remains at zero and the process moves on to step g which looks for the emergence of the situation whereby the DirectionOfTravel_CAN information indicates reverse gear whereas the vehicle state as coded by the module 7 (see FIG. 2) is greater than or equal to 2 (vehicle in forward gear moving forward slowly or quickly). Upon the emergence of this situation, the VehicleSpeedSignFaultDetected flag is set to 1 (step h). In the absence of this situation, this flag remains at zero and the process moves on to the situation in which DirectionOfTravel_CAN adopts a value indicating a vehicle that is stationary whereas the information VS_kmh relating to the current speed of the vehicle indicates a non-zero value for this speed (step i) because this speed is greater than or equal to a relatively low threshold value such as 20 km/h for example. Upon the emergence of this situation, the aforementioned flag switches to 1 (step j), whereas in the absence of this situation it remains at zero (step k).

Once these three consistency tests have been executed, the variable representative of the direction of travel of the vehicle is saved for the remaining calculations, this value being equal to VSS_n or VSS_nm1 as seen above in conjunction with steps c and d of the flow diagram of FIG. 5.

The three input variables of the control laws for controlling the rear steering angle having thus been validated by the module 6 are used by the means 4 for executing these laws in order firstly to choose the law that applies, and secondly to actually execute this law.

In this connection, according to another feature of the present invention, if any one of the aforementioned flags remains at 1 for a period of time considered to be abnormally long (for example 50 ms) indicating that there is a persistent error in at least one of the input variables of the control laws, something which is liable to introduce error into the steering angle value calculated using these laws, then a “degraded”, but safer, method of calculating this steering angle is substituted for these control laws, this degraded method progressively returning this steering angle to zero. The advantages normally had from adapted adjustment of the value of this angle are then temporarily lost, but this loss is compensated for in an improvement in vehicle safety.

It is now evident that the invention does indeed make the calculation of the rear steering angle safer in the event of a fleeting error in one or more of the input variables involved in this calculation, and also makes the vehicle behave more safely in the event of a persistent error in these variables.

1-15. (canceled)

16. A method for controlling a steering angle of rear wheels of a motor vehicle including a front axle of steered front wheels, the steering angle of which is set by a steering wheel and a rear axle of steered rear wheels, whereby the rear wheel steering angle is taken from a control law that is a function of input variables including at least an angle of rotation of the steering wheel and the speed of the vehicle, the method comprising:
detecting appearance of an erroneous value of at least one of the input variables; and
replacing the value with a reliable earlier value of the variable.

17. The method as claimed in claim 16, wherein if production of the erroneous value persists for a length of time longer than a predetermined duration, then a safer method of calculating the rear steering angle is substituted for the method of calculating the angle defined by the control law.

18. The method as claimed in claim 17, wherein the safer method of calculation progressively returns the rear steering angle to zero.

19. The method as claimed in claim 16, employed in a vehicle including a local communications network including a bus for distributing at least the input variables in a form of sampled digital data, wherein, upon detection of an erroneous value in a current sample of one of the digital data, the sample is replaced by a reliable earlier sample of the data, for calculating the rear steering angle using the control law.

20. The method as claimed in claim 19, wherein a value of the current sample of the data available on the bus is compared against values indicating its invalidity or its absence on the bus, and a value of a flag indicating either one of the invalidity or the absence is set accordingly.

21. The method as claimed in claim 19, wherein, over a sampling period, a vehicle speed gradient is measured, the gradient is compared against a predetermined limit value of the gradient and a value of a flag indicating any exceeding of the limit value is set accordingly.

22. The method as claimed in claim 19, wherein, over a sampling period, a steering wheel angle of rotation gradient is measured, the gradient is compared against a predetermined limit value of the gradient and a value of a flag indicating any exceeding of the limit value is set accordingly.

23. The method as claimed in claim 21, wherein measurement of the gradient is timed.

24. The method as claimed in claim 19, wherein one of the input variables include a direction of travel of the vehicle, wherein consistency of the variable as read off the bus with a state of the vehicle, in forward gear or reverse or alternatively stationary, is checked and a value of a flag indicating any error in the current sample of the variable is set accordingly.

25. The method as claimed in claim 19, wherein, while any one of flags remains in a state indicating an error with the associated input variable for a length of time that exceeds a predetermined duration, the rear steering angle is calculated using the safer method of calculation.

26. A device for implementing the method as claimed in claim 16, comprising:
means for executing the control law;
means sensitive to a rear steering angle instruction taken from the control law to force the angle to adopt the instructed value; and
means for monitoring signals representative of the input variables of the control law that are capable of indicating an error in the current value of any one of the variables and of replacing the current value with a reliable earlier value of the variable.

27. The device as claimed in claim 26, wherein the means for executing the control law comprises means for executing a safer method of calculating the rear steering angle.

28. The device as claimed in claim 26, further comprising state management means sensitive to detection of an error by the means for monitoring the signals and to safer signals delivered by the means for monitoring the signals with regard to speed and direction of travel of the vehicle, so as to deliver reliable information regarding a state of the vehicle, whether stationary, in a forward or reverse gear, to the means for executing the control law so that the means for executing the control law can select the control law appropriately.

29. The device as claimed in claim 28, wherein the information is also delivered to the monitoring means, the monitoring means comprising means for checking consistency of the variable relating to the direction of travel of the vehicle with the information.

30. A motor vehicle comprising a device as claimed in claim 26.
